(19) United States
(12) Patent Application Publication
(10) Pub. No.: US 2026/0132608 A1
(43) Pub. Date: May 14, 2026

(54) PRODUCE SINK

(71) Applicant: TATTNEY-LEE JEAN TARR, Osoyoos (CA)

(72) Inventor: TATTNEY-LEE JEAN TARR, Osoyoos (CA)

(21) Appl. No.: 18/945,105

(22) Filed: Nov. 12, 2024

(51) Int. Cl. E03C 1/184; A47J 43/24; F25B 21/02

(52) U.S. Cl. CPC E03C 1/184; A47J 43/24; F25B 21/02

(57) ABSTRACT

An apparatus and method for chilling food articles within a sink wherein the apparatus comprising a chiller, an inlet extending from a sink to the chiller, an outlet extending from the chiller to the sink and a pump adapted to convey a quantity of fluid contained within the sink through the chiller until a predetermined temperature within the sink is achieved. The method comprises locating the food articles within a sink, introducing a quantity of water into the sink with the food articles and for a predetermined time, drawing off a quantity of the water from the sink through an inlet extending from a sink, passing the water through a chiller to cool the water to a predetermined temperature and introducing the chilled water back into the sink.

### BACKGROUND

### Technical Field

This disclosure relates generally to a method and apparatus for processing and reviving produce

### DESCRIPTION OF RELATED ART

Produce is an important food item that is necessary for a balanced and nutritious diet. Fresh produce is especially desirable. One difficulty with keeping produce fresh for consumption is the propensity of produce to wilt or shrivel. Such wilting occurs when the produce loses water to air or other sources.

It is known that placing such wilted produce within a bath of ice water may assist with recovery and revival of wilted produce. Disadvantageously, such ice baths may have an inconsistent temperature and may subject such produce to unwanted prolonged contact with ice which may potentially further damage the produce. Such methods also have a limited degree of control over the temperature of the water due to the use of ice and may require monitoring to avoid damage to the produce.

### SUMMARY OF THE DISCLOSURE

According to a first embodiment of the present disclosure is an apparatus for chilling food articles within a sink comprising a chiller, an inlet extending from a sink to the chiller, an outlet extending from the chiller to the sink and a pump adapted to convey a quantity of fluid contained within the sink through the chiller until a predetermined temperature within the sink is achieved.

The inlet may extend from the drain of the sink. The apparatus may further comprise an inlet valve assembly operable to control flow of water from the drain to the chiller. The inlet valve assembly may include a valve from the drain to the inlet. The inlet valve assembly may include a drain valve operable to control drainage of water from the sink. The outlets may extend to a plurality of locations around the sink.

The apparatus may further comprise a water makeup inlet operable to receive a quantity of fresh water into the apparatus for introduction to the sink. The water makeup inlet may include a makeup valve operable to control the flow of fresh water into the apparatus. The chiller may comprise thermoelectric cooler.

The apparatus may further comprise a temperature sensor adapted to measure the temperature of water within the sink. The chiller may be adapted to cool water passing therethrough in response to the temperature measured by the temperature sensor. The apparatus may further comprise a controller operable to control the operation of the chiller and pump.

The controller may be operable to control operation of a valve assembly controlling flow of fluid into the inlet and out of the sink through the drain. The controller may be operable to control the operation of at least one of a makeup valve, inlet valve assembly and detergent valve. The controller may be operable to perform at least one of a plurality of predetermined cycles of cooling and cycling chilled water through the sink. The apparatus may further comprise a reservoir of a detergent operable to be introduced into the sink controllable with a detergent valve.

According to a further embodiment of the present disclosure is a system for chilling food articles, the system comprising a sink operable to contain the food articles and a quantity of water and a chiller assembly operable to cool the water within the sink to a predetermined temperature.

The chiller assembly may includes a chiller extending around the exterior of the sink in contact therewith so as to be operable to chill the sidewall of the sink. The chiller assembly may comprising a chiller, an inlet extending from a sink to the chiller, an outlet extending from the chiller to the sink and a pump adapted to convey a quantity of fluid contained within the sink through the chiller until a predetermined temperature within the sink is achieved.

According to a further embodiment of the present disclosure is a method for chilling food articles comprising locating the food articles within a sink, introducing a quantity of water into the sink with the food articles and for a predetermined time, drawing off a quantity of the water from the sink through an inlet extending from a sink, passing the water through a chiller to cool the water to a predetermined temperature and introducing the chilled water back into the sink.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a perspective view of a sink having water chilling means associated therewith according to a first embodiment of the present disclosure.

FIG. 2 is a schematic view of the water chilling system of FIG. 1 according to a first embodiment of the present disclosure.

FIG. 3 is a diagram of a control system for the water chilling system of FIG. 1.

FIG. 4 is a schematic view of a sink drain having an inlet to the water chilling system of FIG. 1 according to a further embodiment of the present disclosure.

FIG. 5 is a perspective view of a sink having a water chilling apparatus applied therearound according to a further embodiment of the present disclosure.

### DETAILED DESCRIPTION

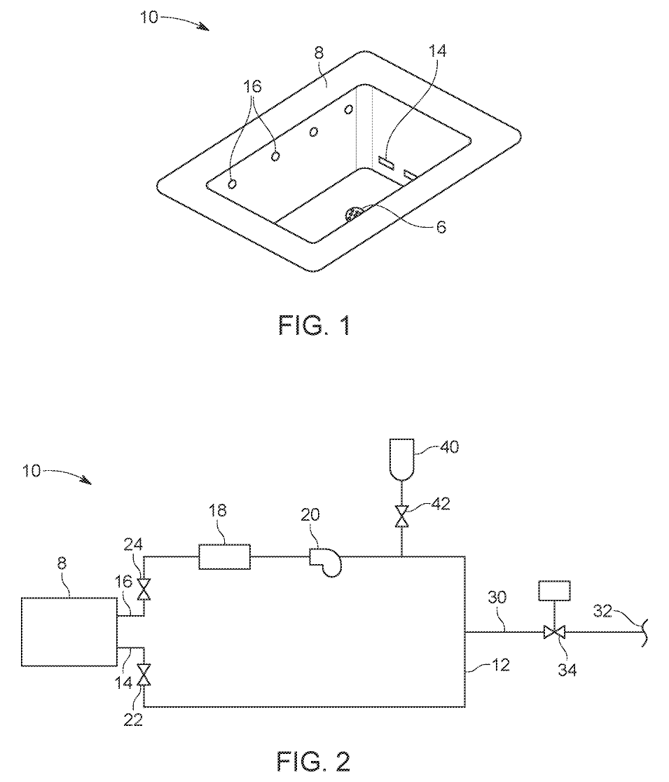

Referring to FIG. 1, an exemplary apparatus for processing food articles is illustrated generally at 10. In particular the apparatus 10 may be utilized for processing, cleaning or reviving wilted produce. The apparatus 10 comprises a cooling circuit 12 applied to and interfacing with a sink 8. In operation, the cooling circuit 12 is adapted to draw off a quantity of water contained within the sink, pass it through the cooling circuit 12 while cooling the water to a desired temperature and returning it to the sink. In operation, the apparatus will have the effect of chilling the water to close to the temperature of ice water which may have the benefit of reviving wilted produce.

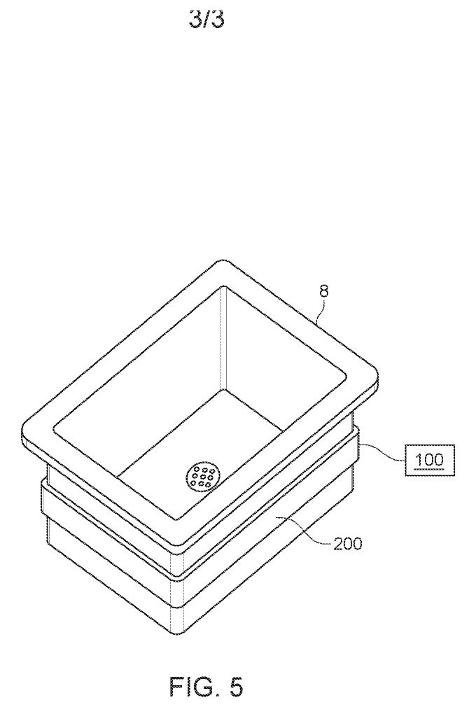

Turning now to FIG. 2, the cooling circuit 12 extends from an outlet 14 from the sink to an inlet 16 into the sink and includes a water chiller 18 and pump 20 therein. The cooling circuit 12 is adapted to draw water out of the sink 8 and through the cooling circuit before injecting the water back into the sink through the inlets. The inlet 14 from the sink may be a passage through the sidewall such as a bore, slot or any other know opening type and may be formed of a single, or multiple openings thereinto. Optionally, the opening 14 may comprise a conduit extending into and terminating within the sink at a depth operable to be submerged within the water contained within the sink. Furthermore, as illustrated in FIG. 4 the inlet 14 may extend from and be in fluid communication with a drain 6 of the sink. It will further be appreciated that filters, screens or the like may be applied over the inlet 14 so as to prevent the inclusion of debris and the light within the cooling circuit 12.

The outlet 16 into the sink 8 may be a passage extending through the sidewall thereof such that the cooling circuit 12 is operable to convey fluid, and in particular water contained within the sink from the inlet to the outlet through a chiller as will be further set out below. The outlet 16 may be of any suitable shape including slots, bores or the like be formed as a single or multiple openings. It will be further appreciate that the outlets 16 may include jets or other directable devices so as to permit the direction of ejected water therefrom to be directed in a direction as desired by a user. As illustrated the outlets 16 may be located in the sink 8 at a location above the inlets 14 although it will be appreciated that other locations may be utilized as well.

The cooling circuit 12 includes a chiller 18 and a pump 20 therein adapted to chill or cool and transport the water in the cooling circuit 12. The pump 20 may be of any suitable type as are commonly known. The chiller 18 may be selected from any known cooling system including, without limitation, refrigeration cycles and thermoelectric coolers as are known. In particular, the conduit forming the cooling circuit 12 may be adapted to pass through the chiller such that the water conveyed therein is cooled by a desired amount by the chiller. Alternatively, one or more portions of the chiller applied thereto in thermal connectively so as to cool the conduit and thereby the water conveyed therein.

As illustrated in FIG. 2, the cooling circuit 12 may optionally include a fresh water make up 30 extending from a municipal or other water source 32. A makeup valve 34 in the freshwater makeup may permit control of the introduction of the fresh water into the cooling circuit 12 as determined by a user or controller as will be further described below. Optionally as illustrated in FIG. 2, the system 10 may include a tank 40 operable to contain a quantity of a substance, such as, by way of non-limiting example a detergent, soap or other cleaning or processing substance therein. The tank may include a detergent valve 42 operable to control the introduction of detergent or any other substance contained within the tank 40 into the cooling circuit 12 as determined by a user or controller as will be further described below.

Furthermore, it will be appreciated that one or both of the inlet 14 and outlet 16 may include an inlet valve 22 or outlet valve 24, respectively therein operable to be opened or closed to isolate the cooing circuit from the sink as determined by a user or controller as will be further described below. Optionally as illustrated in FIG. 4, the inlet valve 22 and inlet 14 may be fluidically connected to the drain 6 of the sink 8. In such a embodiments, the drain may include a drain valve 26 operable to isolate the sink and system 10 from a municipal drain line or an optional sink valve 28 operable to isolate the contents of the sink.

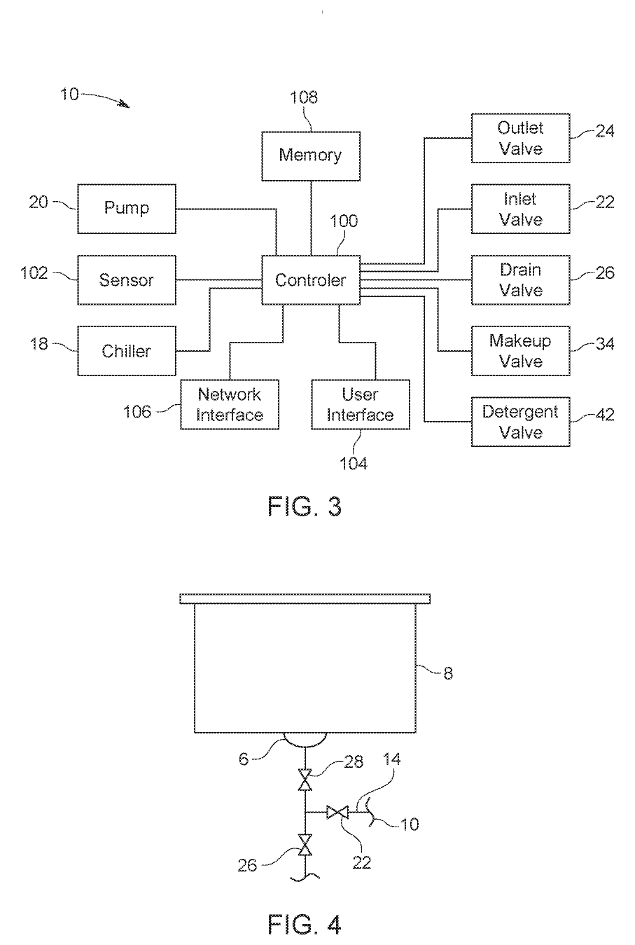

Turning now to FIG. 3, a controller 100 for the system 10 is illustrated as interfacing with the various pumps, valves and chillers as set out above. The term “controller” is intended to broadly encompass any type of device or combination of devices capable of performing the functions described herein, including (without limitation) other types of microprocessing circuits, microcontrollers, other integrated circuits, other types of circuits or combinations of circuits, logic gates or gate arrays, or programmable devices of any sort, for example, either alone or in combination with other such devices located at the same location or remotely from each other. Additional types of processing circuit(s) will be apparent to those ordinarily skilled in the art upon review of this specification, and substitution of any such other types of processing circuit(s) is considered not to depart from the scope of the present invention as defined by the claims appended hereto. In various embodiments, the controller 100 can be implemented as a single-chip, multiple chips and/or other electrical components including one or more integrated circuits and printed circuit boards. The controller 100 may also include internal or external memory 108 that stores machine instructions that when executed by the controller 100, cause the controller to perform one or more of the operations and methods described herein. The system 10 may also include a user interface 104, such as by way of non-limiting example, a keypad, screen or buttons operable to receive user inputs and display one or more statuses of the system and/or a network interface 104 operable to receive and transmit data to or from the controller from a user device such as, by way of non-limiting example, over Bluetooth, internet or wireless transmission as are commonly known. As illustrated, the system 10 may include a sensor, such as, by way of non-limiting example a temperature senor operable to measure the temperature of the water within the sink or cooler circuit 12.

In operation, the controller 10 when instructed by a signal from a user through the network interface 106 or user interface 104 is operable to measure the temperature of the water within the sink 8 and cycle the water through the cooler circuit 12 and the chiller 18 so as to cool the water to a desired temperature. It will be appreciated that the controller will thus control the operation of the chiller 18, pump 20 and valves to cycle and cool the water. The controller may be configured to perform such circulation for a desired time either absolutely or after a desired temperature is reached. The controller may also be operable to cause the makeup valve 34 to permit a desired quantity of makeup water into the system or the detergent valve 42 to introduce a desired quantity of a detergent or soap into the system 10. By operating the drain valve 26, the controller 100 may also be operable to drain the sink and introduce an amount of fresh water to rinse any produce within the sink after an initial cleaning cycle with detergent. The controller 100 may also be operable to permit the water in the produce or other food articles in the sink 8 to soak at the desired temperature for a desired time. It will be appreciated that different cycles for different food articles and purposes, such as, by way of non-limiting example, cleaning, reviving wilted produce or rinsing off dirt or pesticides may be programmed into the controller as required by a user. Furthermore, the cooler circuit 12 may include an aerator for introducing a quantity of air into the water for introduction into the sing 8 through the outlet 16. Such aeration may be provided by the pump 20, or any other element within the system including a discrete aerator.

Optionally, as illustrated in FIG. 5, the sink 8 may include a chiller 200 around an exterior surface of the sink. The chiller 200 may comprise any known chiller including, without limitation, refrigeration cycle and thermoelectric cooling elements. The chiller 200 may be controlled by a controller 100 as set out above. Such alternative embodiments may also include any sensors, valves or the like as set out above for use with an externally piped system.

While specific embodiments have been described and illustrated, such embodiments should be considered illustrative only and not as limiting the disclosure as construed in accordance with the accompanying claims.

What is claimed is:

1. An apparatus for chilling food articles within a sink comprising:
a chiller,
an inlet extending from a sink to the chiller;
an outlet extending from the chiller to the sink; and
a pump adapted to convey a quantity of fluid contained within the sink through the chiller until a predetermined temperature within the sink is achieved.

2. The apparatus of claim 1 wherein the inlet extends from the drain of the sink.

3. The apparatus of claim 2 further comprising an inlet valve assembly operable to control flow of water from the drain to the chiller.

4. The apparatus of claim 3 wherein the inlet valve assembly may include a valve from the drain to the inlet.

5. The apparatus of claim 3 wherein the inlet valve assembly may include a drain valve operable to control drainage of water from the sink.

6. The apparatus of claim 1 wherein the outlets extend to a plurality of locations around the sink.

7. The apparatus of claim 1 further comprising a water makeup inlet operable to receive a quantity of fresh water into the apparatus for introduction to the sink.

8. The apparatus of claim 7 herein the water makeup inlet may include a makeup valve operable to control the flow of fresh water into the apparatus.

9. The apparatus of claim 1 wherein the chiller comprises thermoelectric cooler.

10. The apparatus of claim 1 further comprising a temperature sensor adapted to measure the temperature of water within the sink.

11. The apparatus of claim 10 wherein the chiller is adapted to cool water passing therethrough in response to the temperature measured by the temperature sensor.

12. The apparatus of claim 1 further comprising a controller operable to control the operation of the chiller and pump.

13. The apparatus of claim 12 wherein the controller may be operable to control operation of a valve assembly controlling flow of fluid into the inlet and out of the sink through the drain.

14. The apparatus of claim 13 wherein the controller may be operable to control the operation of at least one of a makeup valve, inlet valve assembly and detergent valve.

15. The apparatus of claim 12 wherein the controller may be operable to perform at least one of a plurality of predetermined cycles of cooling and cycling chilled water through the sink.

16. The apparatus of claim 1 further comprising a reservoir of a detergent operable to be introduced into the sink controllable with a detergent valve.

17. A system for chilling food articles, the system comprising:
a sink operable to contain the food articles and a quantity of water; and
a chiller assembly operable to cool the water within the sink to a predetermined temperature.

18. The system of claim 17 wherein chiller assembly includes a chiller extending around the exterior of the sink in contact therewith so as to be operable to chill the sidewall of the sink.

19. The system of claim 17 wherein the chiller assembly comprises the apparatus of claim 1.

20. A method for chilling food articles comprising:
locating the food articles within a sink;
introducing a quantity of water into the sink with the food articles; and
for a predetermined time:
drawing off a quantity of the water from the sink through an inlet extending from a sink;
passing the water through a chiller to cool the water to a predetermined temperature; and
introducing the chilled water back into the sink.
